(19) United States
(12) Patent Application Publication
(10) Pub. No.: US 2005/0099813 A1
(43) Pub. Date: May 12, 2005

(54) Reflector, auxiliary mirror, light source device and projector

(75) Inventor: Toshiaki Hashizume, Okaya-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/930,914

(22) Filed: Sep. 1, 2004

(30) Foreign Application Priority Data
Sep. 9, 2003 (JP) 2003-316886

(51) Int. Cl. F21V 29/00

(52) U.S. Cl. 362/261; 362/257; 362/263; 362/296; 362/304

(57) ABSTRACT

A reflector with a reflection factor which does not decrease in long-term use even if high-output light-emitting tube is used and a light source device and a projector equipped with such a reflector are provided. The reflector includes a reflector base having a heat resistance temperature of 400° C. or more and a reflecting film composed of a multilayer dielectric film formed on the concave surface of the reflector base and used to reflect the light emitted from a high-pressure mercury lamp toward the illumination region, the difference between the linear thermal expansion coefficient of the reflector base and the linear thermal expansion coefficient of the dielectric material constituting a film with a high refractive index of the multilayer dielectric film being 50×10⁻⁷/K or less.

### BACKGROUND OF THE INVENTION

1. Field of Invention

Exemplary aspects of the present invention relate to a reflector, an auxiliary mirror, a light source device, and a projector.

2. Description of Related Art

In related art projectors, image display is realized by modulating an illumination light, which is emitted from an illumination optical system, according to image information (image signal) by using a liquid-crystal panel or the like to project the modulated light on a screen.

The illumination optical system usually includes a light source device which contains a light emitting tube and a reflector having a concave surface to reflect the light emitted from the light-emitting tube toward the illumination zone. High-pressure mercury lamps, metal halide lamps, and xenon lamps have been used as light-emitting tubes.

### SUMMARY OF THE INVENTION

However, in the above-described light source devices, the temperature around the light-emitting tube increased with the transition to projectors with higher luminosity. This increase in temperature caused a variety of problems, for example, the reflector could be easily cracked. For this reason, for example, in the light source device described in JP-B-7-92527, thermal expansion could be reduced and the aforementioned problems were resolved by using a crystallized glass with a comparatively high heat resistance as a reflector material.

However, the luminosity of projectors has further increased and light-emitting tubes with an output of 200 W and more came into use in the projectors. For this reason, the temperature of the portions of the reflector in the vicinity of the light-emitting tube has increased (to about 400° C. and higher) over that in the related art projectors. The resultant problem was that cracks appeared in the reflecting film in those portions and the reflection factor decreased in a long-term use.

Exemplary aspects of the present invention address and/or resolve the aforementioned and/or other problems and provide a reflector in which the reflection factor does not decrease in a long-term use even if a high-output light-emitting tube is used.

The inventors have conducted a comprehensive study to attain the above by decreasing the difference between the linear thermal expansion coefficient of the reflector base and the average linear thermal expansion coefficient in the reflecting film formed on the concave surface of the reflector base, specifically, by decreasing the difference between the linear thermal expansion coefficient of the reflector base and the linear thermal expansion coefficient of a material constituting a film with a high refractive index of a multilayer dielectric film in the reflecting film to less than a prescribed value.

The reflector in accordance with an exemplary aspect of the present invention includes a reflector base having a heat resistance temperature of 400° C. or more and a reflecting film composed of a multilayer dielectric film formed on the concave surface of the reflector base and used to reflect the light emitted from a light-emitting tube toward an illumination region. The difference between the linear thermal expansion coefficient of the reflector base and the linear thermal expansion coefficient of the dielectric material constituting a film with a high refractive index of the multilayer dielectric film is 50×10⁻⁷/K or less.

Therefore, with the reflector in accordance with an exemplary aspect of the present invention, the difference between the linear thermal expansion coefficient of the reflector base and the linear thermal expansion coefficient of the dielectric material constituting a film with a high refractive index of the multilayer dielectric film is less than the prescribed value even when the reflector base having a heat resistance temperature of 400° C. or more is used as the reflector base. As a result, the difference between the linear thermal expansion coefficient of the reflector base and the average linear thermal expansion coefficient in the reflecting film formed on the concave surface of the reflector base also becomes small. For this reason, even if a high-output light-emitting tube is used and the temperature of the reflector base or multilayer dielectric film rises, stresses appearing between the reflector base and multilayer dielectric film do not exceed the prescribed value and the appearance of cracks in the reflecting film and the decrease of reflection factor can be effectively reduced or prevented.

Further, SiO₂, which is usually used, can be advantageously employed as a dielectric material constituting the film with a low refractive index of the multilayer dielectric film.

With such a configuration, the difference between the linear thermal expansion coefficient of the reflector base and the average linear thermal expansion coefficient in the reflecting film formed on the concave surface of the reflector base can be decreased. As a result, even if a high-output light-emitting tube is used, stresses appearing between the reflector base and multilayer dielectric film do not exceed the prescribed value and the appearance of cracks in the reflecting film and the decrease of reflection factor can be effectively reduced or prevented.

In the reflector in accordance with an exemplary aspect of the present invention, the reflector base may be composed of alumina and the multilayer dielectric film may be composed of a laminated film of SiO₂ as a film with a low refractive index and TiO₂ or Ta₂O₅ as a film with a high refractive index.

With such a configuration, the difference between the linear thermal expansion coefficient (80×10⁻⁷/K) of the alumina serving as the reflector base and the linear thermal expansion coefficient (90×10⁻⁷/K) of the TiO₂ or linear thermal expansion coefficient (50×10⁻⁷/K) of the Ta₂O₅ as a dielectric material constituting the film with a high refractive index of the multilayer dielectric film becomes 50×10⁻⁷/K or less. As a result, even if a high-output light-emitting tube is used, stresses appearing between the reflector base and multilayer dielectric film do not exceed the prescribed value and the appearance of cracks in the reflecting film and the decrease of reflection factor can be effectively reduced or prevented.

In the reflector in accordance with an exemplary aspect of the present invention, the reflector base may be composed of sapphire and the multilayer dielectric film may be composed of a laminated film of SiO₂ as a film with a low refractive index and Ta₂O₅ or TiO₂ as a film with a high refractive index.

With such a configuration, the difference between the linear thermal expansion coefficient (50×10⁻⁷/K) of the sapphire serving as the reflector base and the linear thermal expansion coefficient (50×10⁻⁷/K) of the Ta₂O₅ or linear thermal expansion coefficient (90×10⁻⁷/K) of the TiO₂ as a dielectric material constituting the film with a high refractive index of the multilayer dielectric film becomes 50×10⁻⁷/K or less. As a result, even if a high-output light-emitting tube is used, stresses appearing between the reflector base and multilayer dielectric film do not exceed the prescribed value and the appearance of cracks in the reflecting film and the decrease of reflection factor can be effectively reduced or prevented.

In the reflector in accordance with an exemplary aspect of the present invention, the reflector base may be composed of quartz glass and the multilayer dielectric film may be composed of a laminated film of SiO₂ as a film with a low refractive index and Ta₂O₅ as a film with a high refractive index.

With such a configuration, the difference between the linear thermal expansion coefficient (5×10⁻⁷/K) of the quartz glass serving as the reflector base and the linear thermal expansion coefficient (50×10⁻⁷/K) of the Ta₂O₅ as a dielectric material constituting the film with a high refractive index of the multilayer dielectric film becomes 50×10⁻⁷/K or less. As a result, even if a high-output light-emitting tube is used, stresses appearing between the reflector base and multilayer dielectric film do not exceed the prescribed value and the appearance of cracks in the reflecting film and the decrease of reflection factor can be effectively reduced or prevented.

In the reflector in accordance with an exemplary aspect of the present invention, the reflector base may be composed of crystallized glass and the multilayer dielectric film may be composed of a laminated film of SiO₂ as a film with a low refractive index and Ta₂O₅ as a film with a high refractive index.

With such a configuration, the difference between the linear thermal expansion coefficient (1-5×10⁻⁷/K) of the crystallized glass serving as the reflector base and the linear thermal expansion coefficient (50×10⁻⁷/K) of the Ta₂O₅ as a dielectric material constituting the film with a high refractive index of the multilayer dielectric film becomes 50×10⁻⁷/K or less. As a result, even if a high-output light-emitting tube is used, stresses appearing between the reflector base and multilayer dielectric film do not exceed the prescribed value and the appearance of cracks in the reflecting film and the decrease of reflection factor can be effectively reduced or prevented.

The inventors have discovered that a reflector with a reflection factor which does not decrease in a long-term use even if a high-output light-emitting tube is used can be provided if the difference between the linear thermal expansion coefficient of the reflector base and the linear thermal expansion coefficient of the material constituting the film with a high refractive index of the multilayer dielectric film is made less than the prescribed value, as described hereinabove. However, the inventors have also discovered that the same can be said with respect to an auxiliary mirror in which the temperature of the concave surface may reach 600-1000° C. when the projector is used.

The auxiliary mirror in accordance with an exemplary aspect of the present invention includes an auxiliary mirror base having a heat resistance temperature of 600° C. or more and a reflecting film composed of a multilayer dielectric film formed on the concave surface of the auxiliary mirror base and used to reflect the light emitted from a light-emitting tube onto the illumination region toward the light-emitting tube. The difference between the linear thermal expansion coefficient of the auxiliary mirror base and the linear thermal expansion coefficient of the dielectric material constituting a film with a high refractive index of the multilayer dielectric film is 50×10⁻⁷/K or less.

Therefore, with the auxiliary mirror in accordance with an exemplary aspect of the present invention, the difference between the linear thermal expansion coefficient of the auxiliary mirror base and the linear thermal expansion coefficient of the dielectric material constituting a film with a high refractive index of the multilayer dielectric film is less than the prescribed value even when the auxiliary mirror base having a heat resistance temperature of 600° C. or more is used as the auxiliary mirror base. As a result, the difference between the linear thermal expansion coefficient of the auxiliary mirror base and the average linear thermal expansion coefficient in the reflecting film formed on the concave surface of the auxiliary mirror base also becomes small. For this reason, even if a high-output light-emitting tube is used and the temperature of the auxiliary mirror base or multilayer dielectric film rises, stresses appearing between the auxiliary mirror base and multilayer dielectric film do not exceed the prescribed value and the appearance of cracks in the reflecting film of the auxiliary mirror and the decrease of reflection factor can be effectively reduced or prevented.

Further, SiO₂, which is usually used, can be advantageously employed as a dielectric material constituting the film with a low refractive index of the multilayer dielectric film.

With such a configuration, the difference between the linear thermal expansion coefficient of the auxiliary mirror base and the average linear thermal expansion coefficient in the reflecting film formed on the concave surface of the auxiliary mirror base can be decreased. As a result, even if a high-output light-emitting tube is used, stresses appearing between the auxiliary mirror base and multilayer dielectric film do not exceed the prescribed value and the appearance of cracks in the reflecting film of the auxiliary mirror and the decrease of reflection factor can be effectively reduced or prevented.

In the auxiliary mirror in accordance with an exemplary aspect of the present invention, the auxiliary mirror base may be composed of alumina and the multilayer dielectric film may be composed of a laminated film of SiO₂ as a film with a low refractive index and TiO₂ or Ta₂O₅ as a film with a high refractive index.

With such a configuration, the difference between the linear thermal expansion coefficient (80×10⁻⁷/K) of the alumina serving as the auxiliary mirror base and the linear thermal expansion coefficient (90×10⁻⁷/K) of the TiO₂ or linear thermal expansion coefficient (50×10⁻⁷/K) of the Ta₂O₅ as a dielectric material constituting the film with a high refractive index of the multilayer dielectric film becomes 50×10⁻⁷/K or less. As a result, even if a high-output light-emitting tube is used, stresses appearing between the auxiliary mirror base and multilayer dielectric film do not exceed the prescribed value and the appearance of cracks in the reflecting film of the auxiliary mirror and the decrease of reflection factor can be effectively reduced or prevented.

In the auxiliary mirror in accordance with an exemplary aspect of the present invention, the auxiliary mirror base may be composed of sapphire and the multilayer dielectric film may be composed of a laminated film of SiO₂ as a film with a low refractive index and Ta₂O₅ or TiO₂ as a film with a high refractive index.

With such a configuration, the difference between the linear thermal expansion coefficient (50×10⁻⁷/K) of the sapphire serving as the auxiliary mirror base and the linear thermal expansion coefficient (50×10⁻⁷/K) of the Ta₂O₅ or linear thermal expansion coefficient (90×10⁻⁷/K) of the TiO₂ as a dielectric material constituting the film with a high refractive index of the multilayer dielectric film becomes 50×10⁻⁷/K or less. As a result, even if a high-output light-emitting tube is used, stresses appearing between the auxiliary mirror base and multilayer dielectric film do not exceed the prescribed value and the appearance of cracks in the reflecting film of the auxiliary mirror and the decrease of reflection factor can be effectively reduced or prevented.

In the auxiliary mirror in accordance with an exemplary aspect of the present invention, the auxiliary mirror base may be composed of quartz glass and the multilayer dielectric film may be composed of a laminated film of SiO₂ as a film with a low refractive index and Ta₂O₅ as a film with a high refractive index.

With such a configuration, the difference between the linear thermal expansion coefficient (5×10⁻⁷/K) of the quartz glass serving as the auxiliary mirror base and the linear thermal expansion coefficient (50×10⁻⁷/K) of the Ta₂O₅ as a dielectric material constituting the film with a high refractive index of the multilayer dielectric film becomes 50×10⁻⁷/K or less. As a result, even if a high-output light-emitting tube is used, stresses appearing between the auxiliary mirror base and multilayer dielectric film do not exceed the prescribed value and the appearance of cracks in the reflecting film of the auxiliary mirror and the decrease of reflection factor can be effectively reduced or prevented.

The light source device in accordance with an exemplary aspect of the present invention includes a light-emitting tube and any of the above-described reflectors. Further, the light source device in accordance with an exemplary aspect of the present invention can further include any of the above-described auxiliary mirrors.

Therefore, because the light source device in accordance with an exemplary aspect of the present invention includes, as described above, the reflector with a reflection factor which does not decrease in a long-term use even if a high-output light-emitting tube is used and an auxiliary mirror with a reflection factor which does not decrease in a long-term use even if a high-output light-emitting tube is used, such a light source device can be advantageously used to increase the luminosity of a projector.

In the light source device in accordance with an exemplary aspect of the present invention, the reflecting film of the auxiliary mirror may have a reflection range wider than that of the reflecting film of the reflector.

When the projector is used, the temperature on the concave surface of the reflector becomes about 400-500° C., whereas the temperature on the concave surface of the auxiliary mirror can reach 600-1000° C. As a result, the reflection range of the reflecting film of the auxiliary mirror shifts to the short wavelength range more significantly that the reflection range of the reflecting film of the reflector. Therefore, if the reflection range of the auxiliary mirror is set in advance and wider than that of the reflector, then the reflection ranges of those reflecting films approach each other when the projector is used and the light utilization efficiency increases.

The inventors have discovered that a reflector with a reflection factor which does not decrease in a long-term use, even if a high-output light-emitting tube is used, can be provided if the difference between the linear thermal expansion coefficient of the reflector base and the linear thermal expansion coefficient of the material constituting the film with a high refractive index of the multilayer dielectric film is made less than the prescribed value, as described hereinabove. However, the inventors have also discovered that the temperature around the light-emitting tube can be decreased and the above can be attained even easier if the below-described heat-dissipating structure is further provided in such a light source device.

The light source device in accordance with an exemplary aspect of the present invention may include a member for heat dissipation which is disposed on the convex surface side of the reflector and thermally connected to the reflector.

In this case, with the light source device in accordance with an exemplary aspect of the present invention, the heat from the reflector can be dissipated to the outside of the system with the member for heat dissipation. Therefore, the temperature around the light-emitting tube can be decreased. As a consequence, even if a high-output light-emitting tube is used, the increase in temperature of the reflector base and multilayer dielectric film is suppressed. As a result, stresses appearing between the reflector base and multilayer dielectric film do not exceed the prescribed value and the appearance of cracks in the reflecting film and the decrease of reflection factor can be reduced or prevented even more effectively.

In the light source device in accordance with an exemplary aspect of the present invention, the member for heat dissipation may include a fin for heat dissipation.

With such a configuration, the reflector heat dissipates heat even more effectively.

Another light source device in accordance with an exemplary aspect of the present invention includes an elliptic reflector including an elliptic reflector base having a heat resistance temperature of 400° C. or more and a reflecting film composed of a multilayer dielectric film formed on the concave surface of the elliptic reflector base. The difference between the linear thermal expansion coefficient of the elliptic reflector base and the linear thermal expansion coefficient of the dielectric material constituting a film with a high refractive index of the multilayer dielectric film being 50×10⁻⁷/K or less, a light-emitting tube having a light emission center thereof in the vicinity of the first focal point of the elliptic reflector, and a parallelizing lens for almost parallelizing the light from the elliptic reflector. The light source device may include a frame for heat dissipation which is disposed in the outer peripheral portion on the concave surface side of the elliptic reflector and is thermally connected to the elliptic reflector and the parallelizing lens is mounted on the frame for heat dissipation.

In this case, with the light source device in accordance with an exemplary aspect of the present invention, the heat from the elliptic reflector can be dissipated to the outside of the system with the frame for heat dissipation. Therefore, the temperature around the light-emitting tube can be decreased. As a consequence, even if a high-output light-emitting tube is used, the increase in temperature of the elliptic reflector base and multilayer dielectric film is suppressed. As a result, stresses appearing between the elliptic reflector base and multilayer dielectric film do not exceed the prescribed value and the appearance of cracks in the reflecting film and the decrease of reflection factor can be reduced or prevented even more effectively.

Further, mounting the parallelizing lens on the frame for heat dissipation makes it possible to integrate the parallelizing lens easily with the elliptic reflector base.

In the other light source device in accordance with an exemplary aspect of the present invention, the frame for heat dissipation may include a fin for heat dissipation.

With such a configuration, the elliptic reflector heat dissipates heat even more effectively.

In another light source device in accordance with an exemplary aspect of the present invention, an IR absorbing layer may be formed on the inner surface of the frame for heat dissipation.

With such a configuration, the IR rays which are essentially unnecessary for image display can be absorbed by the IR absorbing layer and the absorbed heat can be dissipated to the outside of the system from the frame for heat dissipation.

Another light source device in accordance with an exemplary aspect of the present invention may include any of the above-described auxiliary mirrors.

With such a configuration, because the reflection factor of the auxiliary mirror does not decrease in long-term use even if a high-output light-emitting tube is used, the light source device is advantageous for increasing the luminosity of a projector.

The projector in accordance with an exemplary aspect of the present invention includes an illumination optical system including any of the above-described light source devices, an electrooptical modulation device to modulate the light from the illumination optical system according to image information, and a projection optical system to project the modulated light from the electrooptical modulation device.

Therefore, because the projector in accordance with an exemplary aspect of the present invention employs the light source device in which the reflection factor does not decrease in long-term use even if a high-output light-emitting tube is used, the luminosity of the projector can be easily increased.

### BRIEF DESCRIPTION OF THE DRAWINGS

FIG. 1 is a schematic of the light source device of exemplary Embodiment 1;

FIG. 2 illustrates the transmission characteristic of the parabolic reflector in the light source device of exemplary Embodiment 1;

FIG. FIGS. 3(a)-3(b-2) illustrate a method for the manufacture of the parabolic reflector in the light source device of exemplary Embodiment 1;

FIG. 4 is a schematic of the light source device of exemplary Embodiment 2;

FIG. 5 illustrates a transmission characteristic of the elliptic reflector and the auxiliary mirror in the light source device of exemplary Embodiment 2;

FIGS. 6(a)-6(b) are schematics of the member for heat dissipation and frame for heat dissipation in the light source device of exemplary Embodiment 2;

FIG. 7 is a schematic of the light source device of exemplary Embodiment 3;

FIG. 8 shows the relationship between the materials of the bases of the reflector and auxiliary mirror and the material of the film with a high refractive index in the multilayer dielectric film constituting the reflecting film; and

FIG. 9 shows a schematic illustrating an example of the projector of exemplary Embodiment 4.

### DETAILED DESCRIPTION OF EXEMPLARY EMBODIMENTS

The reflector, auxiliary mirror, and light source device employing exemplary aspects of the present invention and a projector equipped therewith will be described below based on the embodiments illustrated by the appended drawings.

### Exemplary Embodiment 1

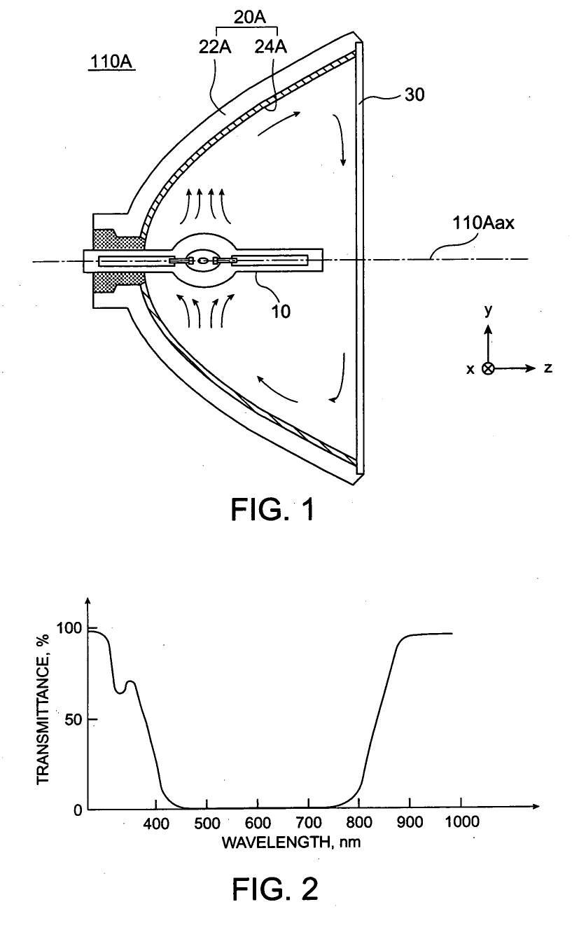

FIG. 1 is a schematic of the light source device 110A of exemplary Embodiment 1 of the present invention. The light source device 110A includes a 200 W high-pressure mercury lamp 10 as a light-emitting tube, a parabolic reflector 20A used to reflect the light from the high-pressure mercury lamp 10 toward the illumination region (not shown in the figure), and a transparent front glass 30 mounted on the opening portion of the parabolic reflector 20A.

The high-pressure mercury lamp 10, as shown in FIG. 1, is composed of a quartz glass tube with a central portion thereof bulging to form a sphere and includes a light-emitting portion in the central part and a pair of sealing portions extending to both sides of the light-emitting portion.

A pair of tungsten electrodes disposed at a prescribed distance from each other, mercury, a rare gas, and a small amount of a halogen are sealed inside the light-emitting portion.

Metallic molybdenum foils electrically connected to the electrodes of the light-emitting portion are introduced into a pair of sealing portions extending at both sides of the light-emitting portion and sealed with a glass material or the like. Lead wires serving as electrode lead-out wires are connected to the metal foils and extend to the outside of the light source device 110A.

If a voltage is applied to the lead wires, a difference in electric potential is generated between the electrodes via the metal foil and discharges, an arc image is generated and the light-emitting portion emits light.

If a reflection preventing coating in the form of a multilayer film including a tantalum oxide film, a hafnium oxide film, a titanium oxide film, and the like is provided on the outer peripheral surface of the light-emitting portion, light loss caused by the reflection of light passing therethrough can be reduced.

The parabolic reflector 20A includes a parabolic reflector base 22A and a reflecting film 24A composed of a multilayer dielectric film formed on the concave surface of the parabolic reflector base 22A. The high-pressure mercury lamp 10 disposed inside the parabolic reflector 20A is so disposed that the light emission center between the electrodes located inside the light-emitting portion is in the vicinity of the focal point of the parabolic reflector 20A.

Further, in the light source device 110A, the light from the high-pressure mercury lamp 10 is reflected by the reflecting film 24A in the parabolic reflector 20A, passes through the front glass 30 as a parallel beam which is almost parallel to an illumination light axis 110Aax and goes out toward the illumination region (+z direction). At this time, the temperature of the parabolic reflector 20A in the zone close to the high-pressure mercury lamp 10 becomes about 400-500° C.

The illumination light axis 110Ax is a central axis of the illumination luminous flux emitted from the light source device 110A.

In the parabolic reflector 20A of the light source device 110A, the parabolic reflector base 22A is formed from quartz glass. Further, the reflecting film 24A is a multilayer dielectric film composed of a laminated film (40 layers) of SiO₂ as a film with a low refractive index and Ta₂O₅ as a film with a high refractive index. Therefore, the difference between the linear thermal expansion coefficient (5×10⁻⁷/K) of the quartz glass serving as the parabolic reflector base 22A and the linear thermal expansion coefficient (50×10⁻⁷/K) of the Ta₂O₅ as a dielectric material constituting the film with a high refractive index of the multilayer dielectric film of the reflecting film 24A becomes 45×10⁻⁷/K. As a result, the difference between the linear thermal expansion coefficient of the parabolic reflector base 22A and the average linear thermal expansion coefficient in the reflecting film 24A is small. Even if such a high-output high-pressure mercury lamp 10 is used, stresses appearing between the parabolic reflector base 22A and reflecting film 24A do not exceed the prescribed value and the appearance of cracks in the reflecting film 24A and the decrease of reflection factor can be effectively reduced or prevented.

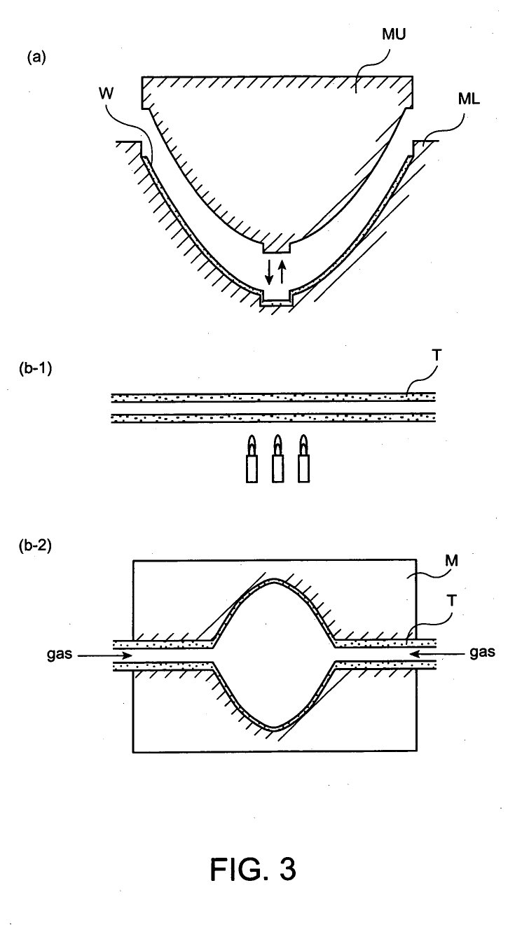

FIG. 2 shows a transmission characteristic (reflection factor) of the reflecting film 24A of the parabolic reflector 20A in the light source device 110A. As shown in FIG. 2, the reflecting film 24A of the parabolic reflector 20A clearly reflects the light in a visible light range which is necessary to display images with the projector.

Further, because quartz glass readily transmits the ultraviolet radiation, heat generation caused by UV absorption is small, and peeling of reflecting film 24A caused by cracking can be reduced or prevented.

FIG. 3 illustrates a method for the manufacture of the parabolic reflector base 22A in the light source device 110A. FIG. 3(a) illustrates a method (press molding method) for the manufacture of the parabolic reflector base. FIG. 3(b-1) and 3(b-2) illustrate another method (gas pressure molding method) for the manufacture of the parabolic reflector base.

With one method (press molding method) for the manufacture of the parabolic reflector base, as shown in FIG. 3(a), quartz glass W, which is the material of the parabolic reflector base, is press molded upon insertion between the lower mold ML and upper mold MU. With this manufacturing method, the parabolic reflector base can be manufactured comparatively easily by the transfer of the upper mold MU. Furthermore, using a highly precise upper mold MU makes it possible to manufacture the high-quality parabolic reflector base 22A having a highly precise concave surface.

The other method (gas pressure molding method) for the manufacture of the parabolic reflector base, as shown in FIG. 3(b-1), includes heating part of a tube T of quartz glass which is the material of the parabolic reflector base. Subsequent operations, as shown in FIG. 3(b-2), include inserting into a mold M, expanding the central part of the tube by applying internal pressure with inert gas and molding so that the inner surface assumes the desired shape and cutting the tube thus molded in the central portion and both end portions. With this manufacturing method, the inner side serving as a reflecting surface uses as a starting shape that of the inner surface of the tube from quartz glass which is usually effectively controlled with the mold during drawing. Therefore, a good reflecting surface can be obtained and a high reflection factor can be constantly maintained. Furthermore, because two molding operations in one cycle can be conducted, the production cost can be reduced. With this manufacturing method, molding is conducted without contact between the reflecting surface and the mold. Therefore, it is possible to manufacture a high-quality parabolic reflector base 22A with a high reflection factor that has a concave surface with a small surface roughness.

### Exemplary Embodiment 2

Exemplary Embodiment 2 of the present invention will be described below based on the appended drawings.

In the explanation provided below, the structure and components identical to those of exemplary Embodiment 1 will be assigned with the same reference symbols and detailed explanation thereof will be omitted or simplified.

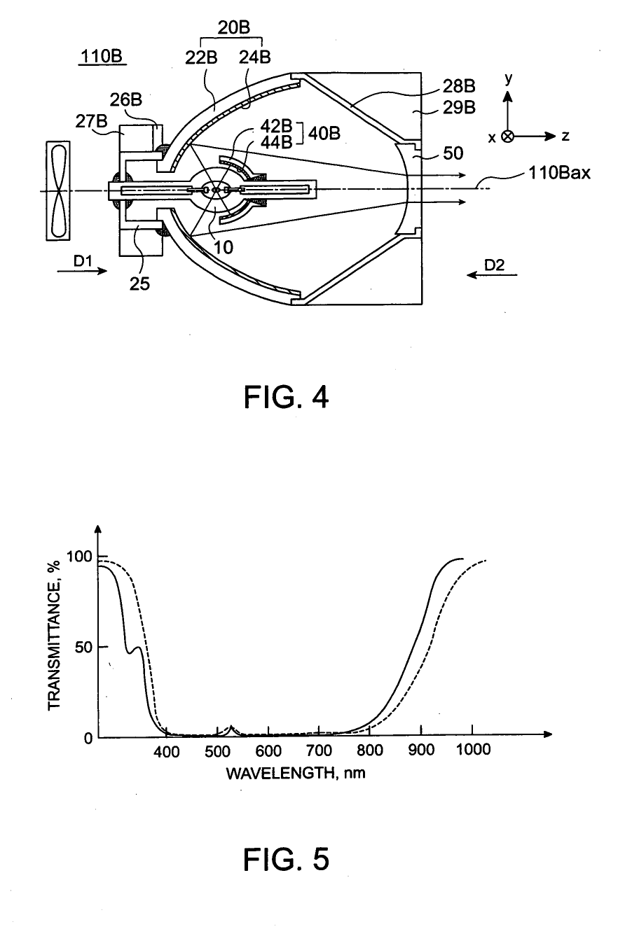

FIG. 4 is a schematic of a light source device 110B of exemplary Embodiment 2 of the present invention. The light source device 110B includes a 200 W high-pressure mercury lamp 10 as a light-emitting tube, an elliptic reflector 20B used to reflect the light from the high-pressure mercury lamp 10 toward the illumination region (not shown in the figure), an auxiliary mirror 40B used to reflect toward the elliptic reflector 20B the light that is emitted from the high-pressure mercury lamp 10 toward the illumination region, and a parallelizing lens 50 for almost parallelizing the light from the elliptic reflector 20B.

The elliptic reflector 20B includes an elliptic reflector base 22B and a reflecting film 24B composed of a multilayer dielectric film formed on the concave surface of the elliptic reflector base 22B. The high-pressure mercury lamp 10, disposed inside the elliptic reflector 20B is disposed so that the light emission center between the electrodes located inside the light-emitting portion is in the vicinity of the first focal position of the ellipsoid of rotation of the elliptic reflector 20B.

Further, in the light source device 110B, the light from the high-pressure mercury lamp 10, is reflected by the reflecting film 24B in the elliptic reflector 20B, becomes a focused light that is focused in the second focal position of the ellipsoid of rotation of the elliptic reflector 20B, passes through the parallelizing lens 50, becomes a parallel beam which is almost parallel to an illumination light axis 110Bax and goes out toward the illumination region (+z direction). At this time, the temperature of the elliptic reflector 20B in the zone close to the high-pressure mercury lamp 10 becomes about 300-400° C.

The illumination light axis 110Bx is a central axis of the illumination luminous flux emitted from the light source device 110B.

The auxiliary mirror 40B includes an auxiliary mirror base 42B and a reflecting film 44B composed of a multilayer dielectric film formed on the concave surface of the auxiliary mirror base 42B. The auxiliary mirror 40B is disposed so that the focal point of the auxiliary mirror 40B is in the vicinity of the light emission center between the electrodes in light-emitting portion of the high-pressure mercury lamp 10. Further, in the light source device 110B, the light emitted from the high-pressure mercury lamp 10 toward the illumination region is reflected by the reflecting film 44B in the auxiliary mirror 40B toward the high-pressure mercury lamp 10 and the light utilization efficiency is increased. At this time, the temperature of the auxiliary mirror 40B is about 600-1000° C.

The auxiliary mirror 40B is a reflecting element disposed opposite the elliptic reflector 20B so as to sandwich the light-emitting portion of the high-pressure mercury lamp 10 therebetween. Because the auxiliary mirror 40B is provided on the illumination region side of the light-emitting portion of the high-pressure mercury lamp 10, as shown in FIG. 4, the luminous flux emitted on the side (illumination region side) opposite to the elliptic reflector 20B, of the luminous flux emitted from the light-emitting portion of the high-pressure mercury lamp 10, is reflected by the auxiliary mirror 40B toward the high-pressure mercury lamp 10, then passes through the high-pressure mercury lamp 10, falls on the elliptic reflector 20B and is reflected by the elliptic reflector 20B, similarly to the luminous flux that fell directly from the high-pressure mercury lamp 10 on the elliptic reflector 20B, toward the second focal point, is focused, passes as a focused light through the parallelizing lens 50, becomes a parallel beam which is almost parallel to an illumination light axis 110Bax and goes out toward the illumination region (+z direction).

As described above, because the auxiliary mirror 40B is used, the luminous flux emitted from the high-pressure mercury lamp 10 to the side (non-illuminated region side) opposite to the elliptic reflector 20B can be caused to fall on the elliptic reflector 20B similarly to the luminous flux that directly fell from the high-pressure mercury lamp 10 on the elliptic reflector 20B.

In the related art light source devices that are not provided with the auxiliary mirror 40B, the luminous flux emitted from the high-pressure mercury lamp 10 has to be focused in the second focal position only with the elliptic reflector and the reflecting surface area of the elliptic reflector has to be expanded.

However, if the auxiliary mirror 40B is provided, the luminous flux emitted from the high-pressure mercury lamp 10 to the side (non-illuminated region side) opposite to the elliptic reflector 20B can be reflected by the auxiliary mirror 40B backward so as to fall on the elliptic reflector 20B. Therefore, even if the reflecting surface area of the elliptic reflector 20B is small, almost the entire luminous flux emitted from the high-pressure mercury lamp 10 can be so emitted as to be focused in the constant position and the aperture diameter and the size of the elliptic reflector 20B in the direction of the illumination light axis 110Bax can be reduced. Thus, the light source device 110B can be miniaturized and the incorporation of the light source device 110B into another optical device is facilitated.

Further, because the auxiliary mirror 40B is provided, the focus spot diameter in the second focal point of the elliptic reflector 20B is decreased. Therefore, even if the first focal point and second focal point of the elliptic reflector 20B are brought close to each other, almost the entire light emitted from the high-pressure mercury lamp 10 can be focused by the elliptic reflector 20B and auxiliary mirror 40B in the second focal point and used, thereby greatly increasing the light utilization efficiency. Therefore, the high-pressure mercury lamp 10 with a comparatively low output can be employed and the temperature of the light source device 110B can be decreased.

In the elliptic reflector 20B of the light source device 110B, the elliptic reflector base 22B is from transparent alumina. The reflecting film 24B is a multilayer dielectric film composed of a laminated film (40 layers) of SiO₂ as a film with a low refractive index and TiO₂ as a film with a high refractive index.

Therefore, the difference between the linear thermal expansion coefficient (80×10⁻⁷/K) of the transparent alumina serving as the elliptic reflector base 22B and the linear thermal expansion coefficient (90×10⁻⁷/K) of the TiO₂ as a dielectric material constituting the film with a high refractive index of the multilayer dielectric film of the reflecting film 24B becomes 10×10⁻⁷/K As a result, the difference between the linear thermal expansion coefficient of the elliptic reflector base 22B and the average linear thermal expansion coefficient in the reflecting film 24B is small. Even if such a high-output high-pressure mercury lamp 10 is used, stresses appearing between the elliptic reflector base 22B and reflecting film 24B do not exceed the prescribed value and the appearance of cracks in the reflecting film 24B and the decrease of reflection factor can be effectively reduced or prevented.

In the auxiliary mirror 40B of the light source device 110B, the auxiliary mirror base 42B is from transparent alumina. The reflecting film 44B is a multilayer dielectric film composed of a laminated film (40 layers) of SiO₂ as a film with a low refractive index and TiO₂ as a film with a high refractive index.

Therefore, the difference between the linear thermal expansion coefficient (80×10⁻⁷/K) of the transparent alumina serving as the auxiliary mirror base 42B and the linear thermal expansion coefficient (90×10⁻⁷/K) of the TiO₂ as a dielectric material constituting the film with a high refractive index of the multilayer dielectric film of the reflecting film 44B becomes 10×10⁻⁷/K. As a result, the difference between the linear thermal expansion coefficient of the auxiliary mirror base 42B and the average linear thermal expansion coefficient in the reflecting film 44B is small and even if such a high-output high-pressure mercury lamp 10 is used, stresses appearing between the auxiliary mirror base 42B and reflecting film 44B do not exceed the prescribed value and the appearance of cracks in the reflecting film 44B of the auxiliary mirror 40B and the decrease of reflection factor can be effectively reduced or prevented.

FIG. 5 shows a transmission characteristic (reflection factor) of the reflecting film 24B (solid line) of the elliptic reflector 20B and the reflecting film 44B (broken line) of the auxiliary mirror 40B in the light source device 110B. As shown in FIG. 5, in the light source device 110B, the reflecting film 44B of the auxiliary mirror 40B has a reflection zone wider than that of the reflecting film 24B of the elliptic reflector 20B.

When the projector is used, the temperature of the portion of the concave surface of the elliptic reflector 20B that is close to the high-pressure mercury lamp 10 is about 300-400° C., whereas the temperature at the concave surface of the auxiliary mirror 40B becomes as high as 600-1000° C. Therefore, the reflection zone of the reflecting film 44B of the auxiliary mirror 40B shifts to shorter wavelength with respect to that of the reflecting film 24B of the elliptic reflector 20B. Therefore, as shown in FIG. 5, if the reflection zone of the reflecting film 44B of the auxiliary mirror 40B is set in advance wider than the reflection zone of the reflecting film 24B of the elliptic reflector 20B, then the reflection zones of the reflecting films 24B, 44B will approach each other during projector utilization and the light utilization efficiency will increase.

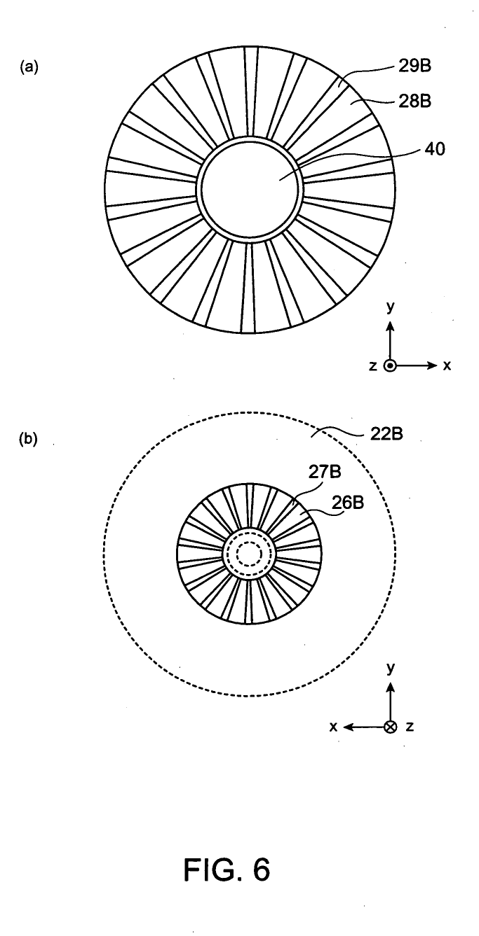

In the light source device 110B of exemplary Embodiment 2, as shown in FIG. 4, and FIG. 6, a lamp fixing body 25 made from glass is joined to the open portion of the elliptic reflector 20B on the convex side thereof. The high-pressure mercury lamp 10 and a member 26B for heat dissipation are connected and fixed to the lamp fixing body 25. Further, there is also provided a frame 28B for heat dissipation disposed in the outer peripheral portion on the concave surface side of the elliptic reflector 20B. FIG. 6 is a schematic showing the member and frame for heat dissipation. Both the member 26B for heat dissipation and the frame 28B for heat dissipation are thermally connected to the elliptic reflector 20B. Further, the parallelizing lens 50 is mounted on the frame 28B for heat dissipation. Because the alumina reflector of exemplary Embodiment 2 has a high thermal conductivity, the heat of the elliptic reflector 20B is transferred to the member 26B for heat dissipation through the lamp fixing body 25 and dissipated.

The member 26 for heat dissipation and frame 28B for heat dissipation are made from copper, which has a high thermal conductivity. Furthermore, an IR absorption layer is formed on the inner surface of the frame 28B for heat dissipation. As shown in FIG. 6, the member 26B for heat dissipation and frame 28B for heat dissipation have multiple heat dissipation fins 27B, 29B for enhanced heat dissipation ability. Further, the radiation efficiency is increased, for example, by oxidizing the surface. Other metals, such as aluminum, can be used instead of copper for the member 26B for heat dissipation and frame 28B for heat dissipation. Further, the lamp fixing body 25, member 26B for heat dissipation, and heat dissipation fin 27B may be formed of the glass with the same thermal conductivity.

With the light source device 110B of exemplary Embodiment 2, the heat of the elliptic reflector 20B can be dissipated to the outside of the system with the member 26B for heat dissipation. Therefore, the temperature around the high-pressure mercury lamp 10 can be decreased. Further, with the light source device 110B of exemplary Embodiment 2, the heat of the elliptic reflector 20B can be also dissipated to the outside of the system with the frame 28B for heat dissipation. As a result, the increase in temperature of the elliptic reflector base 22B and reflecting film 24B can be inhibited even if a high-output and high-pressure mercury lamp 10 is used. As a result, stresses appearing between the elliptic reflector base 22B and reflecting film 24B do not exceed the prescribed value and the appearance of cracks in the reflecting film 24B and the decrease of reflection factor can be effectively reduced or prevented.

Further, with the light source device 110B of exemplary Embodiment 2, the parallelizing lens 50 can be easily integrated with the elliptic reflector 20B by mounting the parallelizing lens 50 on the frame 28B for heat dissipation. Therefore, the light source device 110B has a sealed lamp, thereby providing for high handleability and safety. Thus, even if the lamp collapses, fragments thereof are not scattered to the outside.

Further, in order to increase the effect of exemplary Embodiment 2, it is possible to dispose a cooling fan and create a cooling air flow over the entire outer surface of the heat dissipation fins 27B, 29B and alumina elliptic reflector 20B. Another effective approach is to eliminate the absorption of IR rays by forming the member 26B for heat dissipation, frame 28B for heat dissipation, and heat dissipation fins 27B, 29B from an alumina crystalline body, which is the same material as that of the reflector, and molding them to the same shape.

### Exemplary Embodiment 3

Exemplary Embodiment 3 of the present invention will be described below based on the appended drawings.

In the explanation provided below, the structure and components identical to those of exemplary Embodiments 1 and 2 will be assigned with the same reference symbols and detailed explanation thereof will be omitted or simplified.

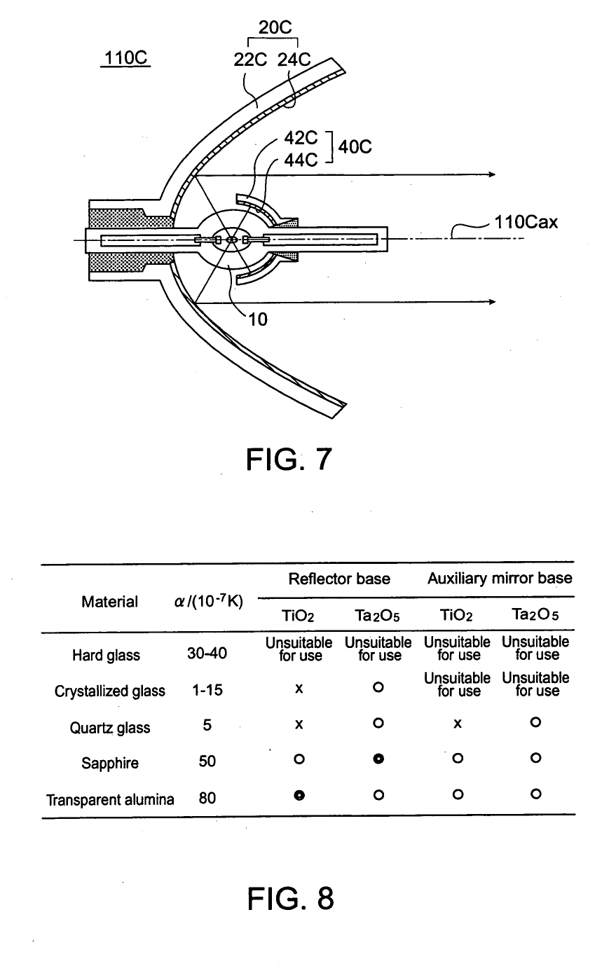

FIG. 7 is a schematic of a light source device 110C of exemplary Embodiment 3 of the present invention. The light source device 110C includes a 200 W high-pressure mercury lamp 10 as a light-emitting tube, a parabolic reflector 20C used to reflect the light from the high-pressure mercury lamp 10 toward the illumination region (not shown in the figure), and an auxiliary mirror 40C used to reflect toward the parabolic reflector 20C the light that is emitted from the high-pressure mercury lamp 10 toward the illumination region.

The parabolic reflector 20C includes a parabolic reflector base 22C and a reflecting film 24C composed of a multilayer dielectric film formed on the concave surface of the parabolic reflector base 22C. The high-pressure mercury lamp 10 disposed inside the parabolic reflector 20C is disposed so that the light emission center between the electrodes located inside the light-emitting portion is in the vicinity of the focal position of the parabolic reflector 20C. Further, in the light source device 110C, the light from the high-pressure mercury lamp 10, is reflected by the reflecting film 24B in the parabolic reflector 20C, becomes an almost parallel beam, and goes out toward the illumination region (+z direction). At this time, the temperature of the parabolic reflector 20C in the zone close to the high-pressure mercury lamp 10 becomes about 450-550° C.

The auxiliary mirror 40C includes an auxiliary mirror base 42C and a reflecting film 44C composed of a multilayer dielectric film formed on the concave surface of the auxiliary mirror base 42C. The auxiliary mirror 42C is disposed so that the focal point of the auxiliary mirror 42C is in the vicinity of the light emission center between the electrodes in light-emitting portion of the high-pressure mercury lamp 10. Further, in the light source device 10C, the light emitted from the high-pressure mercury lamp 10 toward the illumination region is reflected by the reflecting film 44C in the auxiliary mirror 40C toward the high-pressure mercury lamp 10 and the light utilization efficiency is increased. At this time, the temperature of the auxiliary mirror 40C is about 600-1000° C.

The auxiliary mirror 42C is a reflecting element disposed opposite the parabolic reflector 20C so as to sandwich the light-emitting portion of the high-pressure mercury lamp 10 therebetween. Because the auxiliary mirror 42C is provided on the illumination region side of the light-emitting portion of the high-pressure mercury lamp 10, as shown in FIG. 7, the luminous flux emitted on the side (illumination region side) opposite to the parabolic reflector 20C, of the luminous flux emitted from the light-emitting portion of the high-pressure mercury lamp 10, is reflected by the auxiliary mirror 42C toward the high-pressure mercury lamp 10, then passes through the high-pressure mercury lamp 10, falls on the parabolic reflector 20C and is reflected by the parabolic reflector 20C, similarly to the luminous flux that fell directly from the high-pressure mercury lamp 10 on the parabolic reflector 20C, becomes a parallel beam which is almost parallel to an illumination light axis 110Cax, and goes out toward the illumination region (+z direction).

The illumination light axis 110Cx is a central axis of the illumination luminous flux emitted from the light source device 110C.

As described above, because the auxiliary mirror 42C is used, the luminous flux emitted from the high-pressure mercury lamp 10 to the side (non-illuminated region side) opposite to the parabolic reflector 20C can be caused to fall on the parabolic reflector 20C similarly to the luminous flux that directly fell from the high-pressure mercury lamp 10 on the parabolic reflector 20C.

In the related art light source devices that are not provided with the auxiliary mirror 42C, the luminous flux emitted from the high-pressure mercury lamp 10 has to be converted into a parallel beam which is almost parallel to the illumination light axis 100Cax only with the parabolic reflector and the reflecting surface area of the parabolic reflector has to be expanded.

However, when the auxiliary mirror 42C is provided, the luminous flux emitted from the high-pressure mercury lamp 10 to the side (non-illuminated region side) opposite to the parabolic reflector 20C can be reflected by the auxiliary mirror 42C backward so as to fall on the parabolic reflector 20C. Therefore, even if the reflecting surface area of the parabolic reflector 20C is small, almost the entire luminous flux emitted from the high-pressure mercury lamp 10 to the side (non-illuminated region side) opposite to the parabolic reflector 20C can be emitted almost parallel to the illumination light axis 110Cax and the aperture diameter and the size of the parabolic reflector 20C in the direction of the illumination light axis 110Cax can be reduced. Thus, the light source device 110C can be miniaturized and the incorporation of the light source device 110C into another optical device is facilitated.

In the parabolic reflector 20C of the light source device 110C, the parabolic reflector base 22C is from crystallized glass containing LiO₂—SiO₂—Al₂O₃ crystals. Because the crystallized glass absorbs UV rays, the reflector has a temperature higher than that of the reflectors of exemplary Embodiments 1, 2. Further, the reflecting film 24C is a multilayer dielectric film composed of a laminated film (40 layers) of SiO₂ as a film with a low refractive index and Ta₂O₅ as a film with a high refractive index.

Therefore, the difference between the linear thermal expansion coefficient (1-15×10⁻⁷/K) of the crystallized glass serving as the parabolic reflector base 22C and the linear thermal expansion coefficient (50×10⁻⁷/K) of the Ta₂O₅ as a dielectric material constituting the film with a high refractive index of the multilayer dielectric film of the reflecting film 24C becomes 50×10⁻⁷/K or less. As a result, the difference between the linear thermal expansion coefficient of the parabolic reflector base 22C and the average linear thermal expansion coefficient in the reflecting film 24C is small. Even if such a high-output high-pressure mercury lamp 10 is used, stresses appearing between the parabolic reflector base 22C and reflecting film 24C do not exceed the prescribed value and the appearance of cracks in the reflecting film 24C and the decrease of reflection factor can be effectively reduced or prevented.

In the auxiliary mirror 40C of the light source device 110C, the auxiliary mirror base 42C is from quartz glass. The reflecting film 44C is a multilayer dielectric film composed of a laminated film (40 layers) of SiO₂ as a film with a low refractive index and Ta₂O₅ as a film with a high refractive index.

Therefore, the difference between the linear thermal expansion coefficient (5×10⁻⁷/K) of the quartz glass serving as the auxiliary mirror base 42C and the linear thermal expansion coefficient (50×10⁻⁷/K) of the Ta₂O₅ as a dielectric material constituting the film with a high refractive index of the multilayer dielectric film of the reflecting film 44C becomes 45×10⁻⁷/K. As a result, the difference between the linear thermal expansion coefficient of the auxiliary mirror base 42C and the average linear thermal expansion coefficient in the reflecting film 44C is small. Even if such a high-output high-pressure mercury lamp 10 is used, stresses appearing between the auxiliary mirror base 42C and reflecting film 44C do not exceed the prescribed value and the appearance of cracks in the reflecting film 44C of the auxiliary mirror 40C and the decrease of reflection factor can be effectively reduced or prevented.

FIG. 8 shows the relationship between the materials of the bases of the reflector and auxiliary mirror and the materials of the film with a high refractive index in the multilayer dielectric film constituting the reflecting film therein. In FIG. 8, the reference symbol OO denotes the materials which can be used especially advantageously without the decrease in the reflection factor in a long-term use even if a high-output light-emitting tube is used. The reference symbol O denotes the materials which can be used advantageously without the decrease in the reflection factor, and the reference symbol x denotes the materials for which the decrease in the reflection factor is observed and which cannot be used advantageously. Further, the expression “unsuitable for use” relating to the reflector base and auxiliary mirror base indicates that respective materials are used in a state close to a distortion point thereof.

### Exemplary Embodiment 4

Exemplary Embodiment 4 of the present invention will be described below based on the appended drawings.

In the explanation provided below, the structure and components identical to those of exemplary Embodiments 1 to 3 will be assigned with the same reference symbols and detailed explanation thereof will be omitted or simplified.

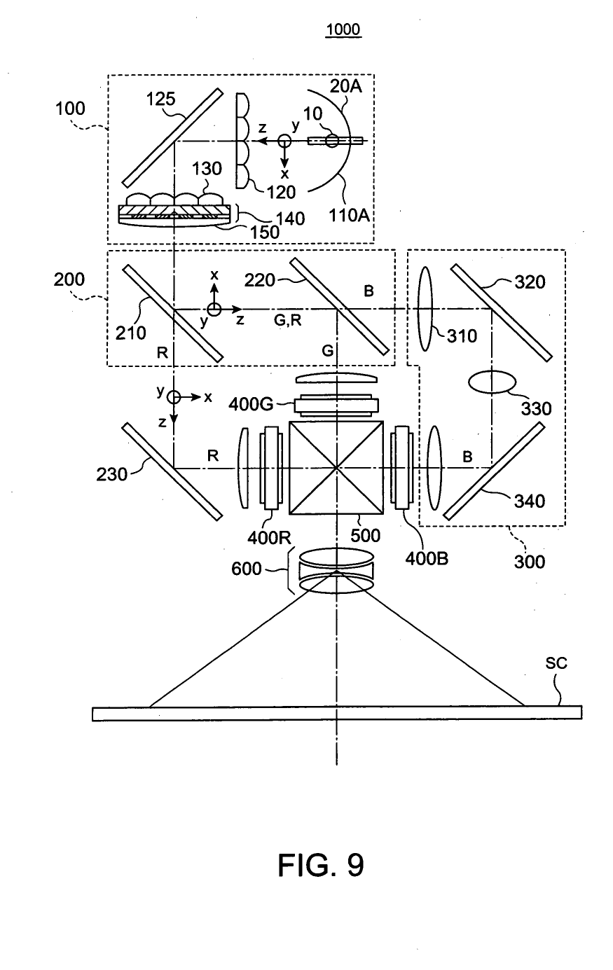

FIG. 9 is a schematic illustrating a projector employing an exemplary aspect of the present invention. A projector 1000 includes an illumination optical system 100, a color separation optical system 200, a relay optical system 300, an optical device, and a projection optical system 600. Optical elements and optical devices constituting those optical systems 100-300 are aligned and accommodated inside a casing for optical components with the prescribed illumination light axis Z set therefor.

The illumination optical system 100 includes the light source device 110A of exemplary Embodiment 1 and a uniform illumination optical system.

In the light source device 110A the luminous flux emitted from the high-pressure mercury lamp 10 is emitted in the fixed direction and illuminates the optical device.

Further, the luminous flux emitted from the light source device 110A outgoes to the uniform illumination optical system.

The uniform illumination optical system splits the luminous flux emitted from the light source device 110A into a plurality of partial luminous fluxes and provides for uniform in-plane illumination intensity of the illumination region. This uniform illumination optical system includes a first lens array 120, a reflecting mirror 125, a second lens array 130, a polarization converting element 140, and a superposition lens 150.

The first lens array 120 has a function of a luminous flux splitting optical element to split the luminous flux emitted from the light source device 110A into a plurality of partial luminous fluxes and includes a plurality of small lenses arranged in the form of a matrix in a plane perpendicular to the illumination light axis Z.

The second lens array 130 is an optical element to condense a plurality of partial luminous fluxes that were split with the above-described first lens array 120 and, similarly to the first lens array 120, has a structure including a plurality of small lenses arranged in the form of a matrix in a plane perpendicular to the illumination light axis Z.

The reflecting mirror 125 reflects the light emitted from the first lens array 120 and causes it to fall on the second lens array.

The polarization converting element 140 uniforms the polarization direction of each partial luminous flux obtained by splitting with the first lens array 120 as linear polarization in almost one direction.

The polarization conversion element 120 (not shown in the figure) has a structure in which reflecting films and polarization separation films disposed at an angle with respect to the illumination light axis z are arranged alternately. The polarization separation films transmit one polarized luminous flux and reflect the other polarized luminous flux of the P polarized luminous flux and S polarized luminous flux contained in each partial luminous flux. The path of the reflected other polarized luminous flux is bent by the reflecting film and it goes out in the outgoing direction of the former polarized luminous flux, that is, in the direction along the illumination light axis Z. Any one of the outgoing polarized luminous fluxes is polarization converted with the phase difference plate provided in the luminous flux outgoing plane of the polarization converting element 140 and the polarization directions of almost all the polarized luminous fluxes are uniformed. Using such a polarization converting element 140 makes it possible to uniform the luminous fluxes emitted from the light source device 110A as polarized luminous fluxes in almost one direction. Therefore, the utilization efficiency of light from the light source used in the optical device can be increased.

The superposition lens 150 is an optical element to condense a plurality of partial luminous fluxes that have passed through the first lens array 120, reflecting mirror 125, second lens array 130, and polarization converting element 140 and superimposing them on image formation regions of the three below-described liquid-crystal display devices 400R, 400G, 400B of the optical device.

The luminous flux outgoing from the superposition lens 150 goes out to the color separation optical system 200.

The color separation optical system 200 includes two dichroic mirrors 210, 220 and has a function of separating a plurality of partial luminous fluxes outgoing from the illumination optical system 100 into three color lights, red (R), green (G), blue (B), with dichroic mirrors 210, 220.

The dichroic mirrors 210, 220 are optical elements in which a wavelength selection film is formed on a substrate. This film reflects the luminous flux in the prescribed wavelength range and transmitting the luminous fluxes in other wavelength ranges. The dichroic mirror 210 disposed in the front stage of the optical path is a mirror transmitting the red color light and reflecting other color lights. Further, the dichroic mirror 220 disposed in the rear stage of the optical path reflects the green color light and transmits the blue color light.

The relay optical system 300 includes an incidence-side lens 310, a relay lens 330, and reflection mirrors 320, 340 and has a function of guiding the blue color light transmitted through the dichroic mirror 220, which constitutes the color separation optical system 200, to the optical device. Further, such a relay optical system 300 is provided in the optical path of the blue color light in order to reduce or prevent the decrease in light utilization efficiency caused, for example, by light scattering due to the fact that the optical path length of the blue color light is larger than that of other color lights. In the present exemplary embodiment, such a configuration is employed because the optical path length of the blue color light is large. However, a configuration can be also considered in which the optical path length of the red color light is increased and the relay optical system 300 is used in the optical path of the red color light.

The red color light separated by the above-described dichroic mirror 210 is bent by the reflecting mirror 230 and then supplied via a field lens to the optical device. The green color light separated by the dichroic mirror 220 is supplied as is via a field lens to the optical device. The blue color light is condensed by the lenses 310, 330 and reflecting mirrors 320, 340 constituting the relay optical field 300, bent and supplied via a field lens to the optical device. The field lenses provided in the front stage of the optical paths of each color light in the optical device are provided to convert each partial luminous flux outgoing from the second lens array 130 into luminous fluxes which are almost parallel to the illumination light axis Z.

The optical device serves to modulate the incident light fluxes according to image information and to form a color image. The optical device is composed of liquid-crystal display devices 400R, 400G, 400B (a liquid-crystal display device on the red color light side is denoted by 400R, a liquid-crystal display device on the green color light side is denoted by 400G, and a liquid-crystal display device on the blue color light side is denoted by 400B) as light modulation devices serving as illumination objects and a cross-dichroic prism 500. Incidence-side polarizing plates are inserted and disposed between the field lens and each liquid-crystal display device 400R, 400G, 400B, and outgoing-side polarizing plates are inserted and disposed between each liquid-crystal display device 400R, 400G, 400B and the cross-dichroic prism 500. Light modulation of each incident color light is conducted by the incidence-side polarizing plates, liquid-crystal display devices 400R, 400G, 400B, and outgoing-side polarizing plates.

In liquid-crystal display devices 400R, 400G, 400B, liquid crystals, which are electrooptical substances, are sealed between a pair of transparent glass substrates. For example, a polysilicon TFT is used as a switching element and the polarization direction of the polarized luminous flux outgoing from the incidence-side polarizing plate 44 is modulated according to the provided image signal.

The cross-dichroic prism 500 is an optical element to form a color image by synthesizing optical images modulated for each color light outgoing from the outgoing-side polarizing plate. The cross-dichroic prism 500 has an almost square shape in a plan view and is obtained by pasting four right prisms. Multilayer dielectric films are formed on the interfaces where the right prisms are pasted to each other. One multilayer dielectric film that has an almost X-like shape reflects the red color light and the other multilayer dielectric film reflects the blue color light. The red color light and blue color light are bent by those multilayer dielectric films and lined up along the propagation direction of the green color light, thereby synthesizing the three color lights.

Then, the color image outgoing from the cross-dichroic prism 500 is projected with a magnification by the projection optical system 600 and a large-area image is formed on a screen SC.

The configuration and function of each component of the projector shown in FIG. 9 are described, for example, in JP-A-10-325954 filed by the applicant of the present application.

In this projector 1000, the light source device 110A shown in FIG. 1 is used as the light source device of the illumination optical system 100. This light source device 110A, as described hereinabove, includes a parabolic reflector 20A which is capable of effectively reducing or preventing the appearance of cracks in the reflecting film 24A and decrease in the reflection factor because the stresses generated between the parabolic reflector base 22A and reflecting film 24A are less than the prescribed value even if the high-output and high-pressure mercury lamp 10 is employed. Therefore, the projector 1000 equipped with the light source device 110A advantageously enables the increase in luminosity without the decrease in reflection factor in a long-term use even if the high-output and high-pressure mercury lamp 10 is employed.

The present invention is not limited to the above-described exemplary embodiments and implementation modes and can be implemented in a variety of modes, without departing from the essence thereof. For example, the following modifications are possible.

The member 26B for heat dissipation explained in exemplary Embodiment 2 may be also used in the light source device 110A of exemplary Embodiment 1 and light source device 110C.

The light source device 110B of exemplary Embodiment 2 may have a configuration comprising no auxiliary mirror 40B.

In the projector 1000 of exemplary Embodiment 4, the light source device 110A was used as the light source device of the illumination optical system 100, but this configuration is not limiting and the light source device 110B or light source device 110C may be also used in the projector 1000.

The projector 1000 of exemplary Embodiment 4 was described with reference only to an example in which three liquid-crystal display devices 400R, 400G, 400B were used. However, the present invention may also be applicable to a projector using only one liquid-crystal display device, a projector using two liquid-crystal display devices, or a projector using four or more liquid-crystal display devices.

In the above-described exemplary embodiments, a liquid-crystal panel of a transmission type was used in which the light incidence plane and light outgoing plane differed from each other. But it is also possible to use a liquid-crystal panel of a reflection type in which the light incidence plane is the same as the light outgoing plane.

The projector 1000 of the above-described exemplary embodiments is an example of a transmission-type projector employing the light source device in accordance with an exemplary aspect of the present invention. However, the present invention may be also applied to reflection-type projectors. Here, the “transmission type” means a type in which an electrooptical device serving as light modulation device, much like a transmission-type liquid-crystal panel, transmits the light, and the “reflection type” means a type in which an electrooptical device serving as a light modulation device, much like a reflection-type liquid-crystal panel, reflects the light. The effect obtained when the present invention is applied to the reflection-type projectors is identical to that obtained with the transmission-type projector.

In the above-described exemplary embodiment, the projector 1000 used a liquid-crystal panel as an electrooptical devices, but this configuration is not limiting. Thus, generally any devices modulating the incident light according to image information may be used, a micromirror-type light modulation device being an example of such devices. For example, DMD (Digital Micromirror Device) (trade name of TI Inc.) can be used as the micromirror-type light modulation device.

1. An auxiliary mirror, comprising:
an auxiliary mirror base having a heat resistance temperature of 600° C. or more and a reflecting film composed of a multilayer dielectric film formed on a concave surface of the auxiliary mirror base and used to reflect the light emitted from a light-emitting tube onto an illumination region toward the light-emitting tube,
a difference between a linear thermal expansion coefficient of the auxiliary mirror base and a linear thermal expansion coefficient of a dielectric material constituting a film with a high refractive index of the multilayer dielectric film being 50×10⁻⁷/K or less.

2. The auxiliary mirror according to claim 1, the auxiliary mirror base being composed of alumina and the multilayer dielectric film being composed of SiO₂ as a film with a low refractive index and TiO₂ or Ta₂O₅ as a film with a high refractive index.

3. The auxiliary mirror according to claim 1, the auxiliary mirror base being composed of sapphire and the multilayer dielectric film being composed of SiO₂ as a film with a low refractive index and Ta₂O₅ or TiO₂ as a film with a high refractive index.

4. The auxiliary mirror according to claim 1, the auxiliary mirror base being composed of quartz glass and the multilayer dielectric film being composed of SiO₂ as a film with a low refractive index and Ta₂O₅ as a film with a high refractive index.

5. A reflector, comprising:
a reflector base having a heat resistance temperature of 400° C. or more and a reflecting film composed of a multilayer dielectric film formed on a concave surface of the reflector base and used to reflect light emitted from a light-emitting tube toward an illumination region,
a difference between a linear thermal expansion coefficient of the reflector base and a linear thermal expansion coefficient of a dielectric material constituting a film with a high refractive index of the multilayer dielectric film being 50×10⁻⁷/K or less.

6. The reflector according to claim 5, the reflector base being composed of alumina and the multilayer dielectric film being composed of SiO₂ as a film with a low refractive index and TiO₂ or Ta₂O₅ as a film with a high refractive index.

7. The reflector according to claim 5, the reflector base being composed of sapphire and the multilayer dielectric film being composed of SiO₂ as a film with a low refractive index and Ta₂O₅ or TiO₂ as a film with a high refractive index.

8. The reflector according to claim 5, the reflector base being composed of quartz glass and the multilayer dielectric film being composed of SiO₂ as a film with a low refractive index and Ta₂O₅ as a film with a high refractive index.

9. The reflector according to claim 5, the reflector base being composed of crystallized glass and the multilayer dielectric film being composed of SiO₂ as a film with a low refractive index and Ta₂O₅ as a film with a high refractive index.

10. A light source device, comprising:
a light-emitting tube and the reflector described in claim 5.

11. The light source device according to claim 10, the reflector base of the reflector being composed of alumina and the multilayer dielectric film being composed of SiO₂ as a film with a low refractive index and TiO₂ or Ta₂O₅ as a film with a high refractive index.

12. The light source device according to claim 10, the reflector base of the reflector being composed of sapphire and the multilayer dielectric film being composed of SiO₂ as a film with a low refractive index and Ta₂O₅ or TiO₂ as a film with a high refractive index.

13. The light source device according to claim 10, the reflector base of the reflector being composed of quartz glass and the multilayer dielectric film being composed of SiO₂ as a film with a low refractive index and Ta₂O₅ as a film with a high refractive index.

14. The light source device according to claim 10, the reflector base of the reflector being composed of crystallized glass and the multilayer dielectric film being composed of SiO₂ as a film with a low refractive index and Ta₂O₅ as a film with a high refractive index.

15. The light source device according to claim 10, further comprising:
a member for heat dissipation which is disposed on the convex surface side of the reflector and thermally connected to the reflector.

16. The light source device according to claim 15, the member for heat dissipation being a fin for heat dissipation.

17. A projector, comprising:
an illumination optical system including the light source device described in claim 10;
an electrooptical modulation device to modulate the light from the illumination optical system according to image information; and
a projection optical system to project the modulated light from the electrooptical modulation device.

18. The projector according to claim 17, the reflector base of the reflector of the light source device being composed of alumina and the multilayer dielectric film being composed of SiO₂ as a film with a low refractive index and TiO₂ or Ta₂O₅ as a film with a high refractive index.

19. The projector according to claim 17, the reflector base of the reflector of the light source device being composed of sapphire and the multilayer dielectric film being composed of SiO₂ as a film with a low refractive index and Ta₂O₅ or TiO₂ as a film with a high refractive index.

20. The projector according to claim 17, the reflector base of the reflector of the light source device being composed of quartz glass and the multilayer dielectric film being composed of SiO₂ as a film with a low refractive index and Ta₂O₅ as a film with a high refractive index.

21. The projector according to claim 17, the reflector base of the reflector of the light source device being composed of crystallized glass and the multilayer dielectric film being composed of SiO₂ as a film with a low refractive index and Ta₂O₅ as a film with a high refractive index.

22. The light source device according to claim 10, comprising:
an auxiliary mirror used to reflect the light emitted from the light-emitting tube onto an illumination region toward the light-emitting tube,
the auxiliary mirror including an auxiliary mirror base having a heat resistance temperature of 600° C. or more and a reflecting film composed of a multilayer dielectric film formed on a concave surface of the auxiliary mirror base, and
a difference between a linear thermal expansion coefficient of the auxiliary mirror base and a linear thermal expansion coefficient of a dielectric material constituting a film with a high refractive index of the multilayer dielectric film being 50×10⁻⁷/K or less.

23. The light source device according to claim 22, the auxiliary mirror base of the auxiliary mirror being composed of alumina and the multilayer dielectric film being composed of SiO₂ as a film with a low refractive index and TiO₂ or Ta₂O₅ as a film with a high refractive index.

24. The light source device according to claim 22, the auxiliary mirror base of the auxiliary mirror being composed of sapphire and the multilayer dielectric film being composed of SiO₂ as a film with a low refractive index and Ta₂O₅ or TiO₂ as a film with a high refractive index.

25. The light source device according to claim 22, the auxiliary mirror base of the auxiliary mirror being composed of quartz glass and the multilayer dielectric film being composed of SiO₂ as a film with a low refractive index and Ta₂O₅ as a film with a high refractive index.

26. The light source device according to claim 22, the reflecting film of the auxiliary mirror having a reflection range wider than that of the reflecting film of the reflector.

27. A projector, comprising:
an illumination optical system including the light source device described in claim 22;
an electrooptical modulation device to modulate the light from the illumination optical system according to image information; and
a projection optical system to project the modulated light from the electrooptical modulation device.

28. The projector according to claim 27, the auxiliary mirror base of the auxiliary mirror of the light source device being composed of alumina and the multilayer dielectric film being composed of SiO₂ as a film with a low refractive index and TiO₂ or Ta₂O₅ as a film with a high refractive index.

29. The projector according to claim 27, the auxiliary mirror base of the auxiliary mirror of the light source device being composed of sapphire and the multilayer dielectric film being composed of SiO₂ as a film with a low refractive index and Ta₂O₅ or TiO₂ as a film with a high refractive index.

30. The projector according to claim 27, the auxiliary mirror base of the auxiliary mirror of the light source device being composed of quartz glass and the multilayer dielectric film being composed of SiO₂ as a film with a low refractive index and Ta₂O₅ as a film with a high refractive index.

31. A light source device, comprising:
an elliptic reflector including an elliptic reflector base having a heat resistance temperature of 400° C. or more and a reflecting film composed of a multilayer dielectric film formed on a concave surface of the elliptic reflector, a difference between a linear thermal expansion coefficient of the elliptic reflector base and a linear thermal expansion coefficient of the dielectric material constituting a film with a high refractive index of the multilayer dielectric film being 50×10⁻⁷/K or less;
a light-emitting tube having a light emission center thereof in the vicinity of a first focal point of the elliptic reflector;
a parallelizing lens for almost parallelizing the light from the elliptic reflector; and
a frame for heat dissipation which is disposed in an outer peripheral portion on a concave surface side of the elliptic reflector and is thermally connected to the elliptic reflector and the parallelizing lens is mounted on the frame for heat dissipation.

32. The light source device according to claim 31,
the frame for heat dissipation having a fin for heat dissipation.

33. The light source device according to claim 31, an IR absorbing layer being formed on the inner surface of the frame for heat dissipation.

34. A projector, comprising:
an illumination optical system including the light source device described in claim 31;
an electrooptical modulation device to modulate the light from the illumination optical system according to image information; and
a projection optical system to project the modulated light from the electrooptical modulation device.

35. The light source device described in claim 31, the light source device further comprising:
an auxiliary mirror used to reflect the light emitted from the light-emitting tube onto an illumination region toward the light-emitting tube,
the auxiliary mirror including an auxiliary mirror base having a heat resistance temperature of 600° C. or more and a reflecting film composed of a multilayer dielectric film formed on the concave surface of the auxiliary mirror base, and
a difference between a linear thermal expansion coefficient of the auxiliary mirror base and a linear thermal expansion coefficient of the dielectric material constituting a film with a high refractive index of the multilayer dielectric film being 50×10⁻⁷/K or less.

36. The light source device according to claim 35, the auxiliary mirror base of the auxiliary mirror being composed of alumina and the multilayer dielectric film being composed of SiO₂ as a film with a low refractive index and TiO₂ or Ta₂O₅ as a film with a high refractive index.

37. The light source device according to claim 35, the auxiliary mirror base of the auxiliary mirror being composed of sapphire and the multilayer dielectric film being composed of SiO₂ as a film with a low refractive index and Ta₂O₅ or TiO₂ as a film with a high refractive index.

38. The light source device according to claim 35, the auxiliary mirror base of the auxiliary mirror being composed of quartz glass and the multilayer dielectric film being composed of SiO₂ as a film with a low refractive index and Ta₂O₅ as a film with a high refractive index.

39. A projector, comprising:
an illumination optical system including the light source device described in claim 35;
an electrooptical modulation device to modulate the light from the illumination optical system according to image information; and
a projection optical system to project the modulated light from the electrooptical modulation device.
